(19) United States
(12) Patent Application Publication
(10) Pub. No.: US 2017/0245171 A1
(43) Pub. Date: Aug. 24, 2017

(54) METHOD AND APPARATUS FOR BUFFER STATUS REPORT IN MOBILE COMMUNICATION SYSTEM

(71) Applicant: ELECTRONICS AND TELECOMMUNICATIONS RESEARCH INSTITUTE, Daejeon (KR)

(72) Inventors: Soojung JUNG, Daejeon (KR); Sung Cheol CHANG, Daejeon (KR); Won-Ik KIM, Daejeon (KR); Seungkwon CHO, Daejeon (KR)

(73) Assignee: ELECTRONICS AND TELECOMMUNICATIONS RESEARCH INSTITUTE, Daejeon (KR)

(21) Appl. No.: 15/439,362

(22) Filed: Feb. 22, 2017

(30) Foreign Application Priority Data
Feb. 24, 2016 (KR) 10-2016-0022144

(51) Int. Cl. H04W 28/02; H04W 72/04; H04L 12/26

(52) U.S. Cl. CPC H04W 28/0278; H04L 43/0852; H04W 72/0413; H04W 72/042

(57) ABSTRACT

Disclosed herein are a method and an apparatus for a buffer status report in a mobile communication system. The method for a buffer status report includes setting a new QoS class identifier (QCI) value for supporting a radio bearer (RB) added for a low latency service; and allocating a logical channel of a RB for an existing service and a logical channel of a RB for the low latency service to logical channel groups (LCGs) in consideration of the newly set QCI value. Further the buffer status report for each logical channel performed in an LCG unit is received.

### CROSS-REFERENCE TO RELATED APPLICATION

This application claims priority to and the benefit of Korean Patent Application No. 10-2016-0022144 filed in the Korean Intellectual Property Office on Feb. 24, 2016, the entire contents of which are incorporated herein by reference.

### STATEMENT REGARDING PRIOR DISCLOSURES BY THE INVENTOR OR A JOINT INVENTOR

Applicant hereby states under 37 CFR 1.77(b)(6) that Soojung JUNG, Sung Cheol CHANG, Won-Ik KIM, Seungkwon CHO, Low Latency Specification Description Data-MAC, Jul. 31, 2015, is designated as a grace period inventor disclosure. The disclosure: (1) was made one year or less before the effective filing date of the claimed invention; (2) names the inventor or a joint inventor as an author; and (3) does not name additional persons as authors.

### BACKGROUND OF THE INVENTION

(a) Field of the Invention

The present invention relates to a method and an apparatus for a buffer status report in a mobile communication system.

(b) Description of the Related Art

In the existing mobile communication, for example, a long term evolution (LTE)/LTE-advanced (LTE-A) system, a scheduler of a base station performs two functions of downlink resource allocation and uplink resource allocation. At the time of the uplink resource allocation, the base station performs resource allocation in consideration of buffer status information of a terminal. For this purpose, the terminal periodically reports the buffer status to the scheduler of the base station or reports the buffer status to the base station when the resource allocation is required for data transmission to the base station through uplink. The scheduler of the base station predicts uplink resource requirements of each terminal and performs scheduling by referring to the received buffer status of each terminal to allocate an uplink resource to the terminal.

The buffer status report performed by the terminal is made in a logical channel group (LCG) unit, in which the LCG is determined by the base station in consideration of QoS class identifier (QCI, 1≦QCI≦9) corresponding to quality of service (QoS) information of each radio bearer (RB).

In recent years, researches for a low latency service requiring a delay time within several ms in a mobile communication field have been conducted and a short latency time is required in a radio section for the low latency service. To achieve this, a transmission time interval (TTI) having a length of 1 ms of the existing system (for example, 3GPP LTE-A) is designed to have a short length of tens of ps to hundreds of ps. For example, the transmission time interval is designed to have a short TTI of 100 μs that is about 1/10 compared to the existing length.

The QoS defined in the current mobile communication system (for example: LTE/LTE-A) does not meet requirements of the low latency service. Therefore, to newly support the low latency service in the LTE/LTE-A, there is a need to set a new QoS, RB, and a new QCI value to support the new QoS of the corresponding RB in the LTE/LTE-A. Further, when a new RB is set and a new QCI value is allocated to support the low latency service, to support uplink scheduling of the base station, the buffer status information of logical channels associated with the RB for the newly configured low latency service also needs to be reported to the base station by the terminal.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a method and an apparatus for performing a buffer status report associated with a new low latency service additionally set as well as a buffer status report of the existing services provided while ensuring QoS conventionally defined in a wireless mobile communication system.

The method for a buffer status report includes: setting a new QoS class identifier (QCI) value for supporting a radio bearer (RB) added for a low latency service; and allocating a logical channel of a RB for an existing service and a logical channel of a RB for the low latency service to logical channel groups (LCGs) in consideration of the newly set QCI value.

The allocating of the logical channels to the LCGs may include: allocating the logical channel of the RB for the low latency service and the logical channel of the RB for the existing service to the LCGs, respectively, without changing the number of existing defined LCGs.

The allocating of the logical channels to the LCGs, respectively, may include: separately allocating the logical channel of the RB for the low latency service and the logical channel of the RB for the existing service to the LCGs, respectively; and allocating the logical channel of the RB for the low latency service and the logical channel of the RB for the existing service to the LCGs, respectively; without differentiating the logical channels. When the logical channel of the RB for the low latency service and the logical channel of the RB for the existing service are allocated to the LCGs, respectively, without differentiating the logical channels, the performing of the buffer status report may include configuring a buffer status report message additionally including delay related information of packets and transmitting the configured buffer status report message.

Only the buffer status report messages for the LCGs to which the logical channels of the RB for the low latency service are allocated may include the delay related information.

The allocating of the logical channels to the LCGs may include: allocating the logical channel of the RB of the low latency service and the logical channel of the RB of the existing service to the LCGs, respectively, by increasing the number of existing defined LCGs.

In the allocating of the logical channels to the LCGs, respectively, the logical channel of the RB for the low latency service may be allocated to the LCG added depending on the increase in the number of LCGs and the logical channel of the RB for the existing service may be allocated to the existing LCG.

The allocating of the logical channels to the LCGs may include: separately defining the LCGs for the low latency service in addition to the existing defined LCGs, and allocating the logical channel of the RB for the low latency service to the LCGs for the separately defined low latency service and allocating the logical channel of the RB for the existing service to the existing defined LCGs, respectively.

In the receiving of the buffer status report, a buffer status report message for the buffer status report for each logical channel may be received and a buffer status report message for the logical channel of the RB for the existing service and a buffer status report message for the logical channel of the RB for the low latency service may be allocated different logical channel IDs (LCIDs).

Another embodiment of the present invention provides an apparatus for a buffer status report, including: a radio frequency converter transmitting and receiving a signal through an antenna; and a processor connected to the radio frequency converter and allocating a logical channel group (LCG) and processing the buffer status report, wherein the processor may include: a QCI setting unit setting a new QoS class identifier (QCI) value for supporting a radio bearer (RB) added for a low latency service; and an allocation processing unit allocating a logical channel of a RB for an existing service and a logical channel of a RB for the low latency service to logical channel groups (LCGs) in consideration of the newly set QCI value.

The allocation processing unit may allocate the logical channel of the RB for the low latency service and the logical channel of the RB for the existing service to the LCGs, respectively, while differentiating the logical channels or allocates the logical channel of the RB for the low latency service and the logical channel of the RB for the existing service to the LCGs, respectively, without differentiating the logical channels, without changing the number of existing defined LCGs.

The processor may further include: an LCG adding unit increasing the number of existing defined LCGs for the buffer status report or separately defining the LCG for the low latency service. The processor may further include a message receiving unit receiving the buffer status report for each logical channel performed in an LCG unit, and the message receiving unit may receive a buffer status report message additionally including delay related information of packets when the allocation processing unit allocates the logical channel of the RB for the low latency service and the logical channel of the RB for the existing service to the LCGs, respectively, without differentiating the logical channels.

According to an exemplary embodiment of the present invention, when a new RB is set to support the low latency service, a new QCI value for supporting the new QOS for the new RB may be set and the report of the buffer status information of the logical channels associated with the RB for the low latency service may be performed based on the newly set QCI value.

Therefore, the resource allocation of the base station may be made in consideration of the requirements of the low latency service requesting a new QoS. As a result, it is possible to provide various services for the short transmission latency in the radio section.

### BRIEF DESCRIPTION OF THE DRAWINGS

FIG. 1 is a diagram illustrating a structure of a BSR message.

FIG. 2 is an exemplified diagram illustrating an LCG allocation relationship with the QCI of the RB.

FIGS. 3 and 4 are exemplified diagrams illustrating the LCG allocation in consideration of the QCI according to a first exemplary embodiment of the present invention.

FIG. 5 is an exemplified diagram illustrating a structure of a BSR message according to an exemplary embodiment of the present invention.

FIG. 6 is an exemplified diagram illustrating LCG allocation in consideration of QCI according to a second exemplary embodiment of the present invention.

FIG. 7 is an exemplified diagram illustrating a structure of a BSR message according to a second exemplary embodiment of the present invention.

FIG. 8 is an exemplified diagram illustrating LCG allocation in consideration of QCI according to a third exemplary embodiment of the present invention.

FIG. 9 is an exemplified diagram illustrating a structure of a BSR message according to a third exemplary embodiment of the present invention.

FIG. 10 is a flow chart of a method for a buffer status report according to an exemplary embodiment of the present invention.

FIG. 11 is a configuration diagram of an apparatus for a buffer status report according to an exemplary embodiment of the present invention.

### DETAILED DESCRIPTION OF THE EMBODIMENTS

In the following detailed description, only certain example embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification. Throughout the present specification, unless explicitly described to the contrary, “comprising” any components will be understood to imply the inclusion of other elements rather than the exclusion of any other elements.

Throughout the specification, a terminal may refer to a mobile terminal (MT), a mobile station (MS), an advanced mobile station (AMS), a high reliability mobile station (HR-MS), a subscriber station (SS), a portable subscriber station (PSS), an access terminal (AT), user equipment (UE), and the like and may also include all or some of the functions of the MT, the MS, the AMS, the HR-MS, the SS, the PSS, the AT, the UE, and the like

Further, the base station (BS) may be called an advanced base station (ABS), a high reliability base station (HR-BS), a node B, an evolved node B (eNodeB), an access point (AP), a radio access station (RAS), a base transceiver station (BTS), a mobile multihop relay (MMR)-BS, a relay station (RS) serving as a base station, a relay node (RN) serving as a base station, an advanced relay station (RS) serving as a base station, a high reliability relay station (HR-RS) serving as a base station, small base stations (a femto base station (femoto BS), a home node B (HNB), a home eNodeB (HeNB), a pico base station (pico BS), a macro base station (macro BS), a micro base station (micro BS), and the like), and the like and may also include all or some of the functions of the ABS, the HR-BS, the node B, the eNodeB, the AP, the RAS, the BTS, the MMR-BS, the RS, the RN, the ARS, the HR-RS, the small base stations, and the like.

Hereinafter, a method and an apparatus for a buffer status report in a mobile communication system according to an exemplary embodiment of the present invention will be described with reference to the accompanying drawings.

In a mobile communication system (e.g., LTE/LTE-A), a terminal may report a buffer status to a base station, for example, periodically report the buffer status to the base station or may report the buffer status to the base station if resource allocation is required for data transmission to the base station through uplink

At the time of the buffer status report, the terminal transmits a buffer status report (BSR) message. The BSR message is one of MAC (medium access control) messages (control elements (CEs)) performed in a MAC layer and is classified from other control messages of the MAC layer by a logical channel ID (LCID).

The LCID of the uplink may be shown as the following Table 1.

TABLE 1

| index | LCID value |
|---|---|
| 00000 | CCCH |
| 00001-01010 | Identity of the logical channel |
| 01011 | CCCH |
| 01100-10101 | Reserved |
| 10110 | Truncated Sidelink BSR |
| 10111 | Sidelink BSR |
| 11000 | Dual Connectivity Power Headroom |
| | Report |
| 11001 | Extended Power Headroom Report |
| 11010 | Power Headroom Report |
| 11011 | C-RNTI |
| 11100 | Truncated BSR |
| 11101 | Short BSR |
| 11110 | Long BSR |
| 11111 | Padding |

As shown in the above Table 1, the LCID values of 11100 to 11110 may be allocated to the BSR message.

The buffer status report of the terminal is performed in the logical channel group (LCG) unit, instead of providing information of a buffer status mapped to all activated radio bearers (RBs). The LCG which is a set of logical channels is a minimum unit of the buffer status report. In the mobile communication system (e.g., LTE/LTE-A system), four LCGs may be provided to the terminal.

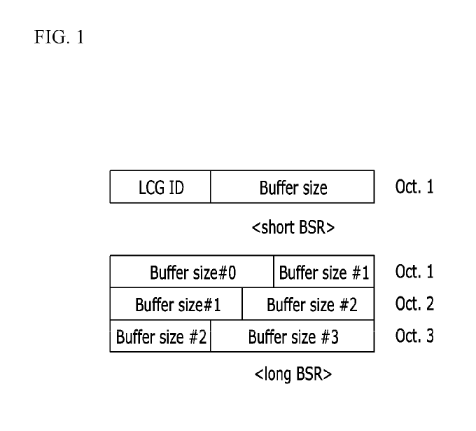

Meanwhile, the BSR message used in the MAC layer may have the structure as illustrated in FIG. 1.

FIG. 1 is a diagram illustrating a structure of a BSR message.

A BSR message type may be divided into a short BSR message and a long BSR message, in which the short BSR message is a message type for the buffer status report for one LCG and the long BSR message is a message type for the buffer status report for all the LCGs. In each type, the LCG ID may consist of 2 bits and a buffer size may consist of 6 bits.

The LCG is determined by the base station in consideration of QoS class identifier (QCI, 1≦QCI≦9) corresponding to quality of service (QoS) information of each RB of a mobile communication system (for example: LTE/LTE-A system). The QCI considers a bearer type (for example: guaranteed bit rates (GBRs) or non-GBR), priority, a packet delay time, a packet loss, or the like and is allocated to each RB depending on the required QoS of service transmitted from each RB.

The following Table 2 is an example of supporting the QoS using the QCI considering the bearer type, the priority, the packet delay time, the packet loss, or the like.

TABLE 2

| | | | Packet | | |
|---|---|---|---|---|---|
| | Bearer | | delay | Packet | |
| QCI | type | Priority | time | loss | Example |
| 1 | GBR | 2 | 100 ms | 10⁻² | VolP call |
| 2 | | 4 | 150 ms | 10⁻³ | Video call |
| 3 | | 3 | 50 ms | | Online game (real-time) |
| 4 | | 5 | 300 ms | 10⁻⁶ | Videostreaming |
| 5 | Non-GBR | 1 | 100 ms | | IMS signaling |
| 6 | | 6 | 300 ms | | Video, TCP-based |
| | | | | | service, for example, |
| | | | | | email, chatting, ftp, or |
| | | | | | the like |
| 7 | | 7 | 100 ms | 10⁻³ | Voice, video, interactive |
| | | | | | game |
| 8 | | 8 | 300 ms | 10⁻⁶ | Video, TCP-based |
| 9 | | 9 | | | service, for example, |
| | | | | | email, chatting, ftp, or |
| | | | | | the like |

Further, packet data convergence protocol (PDCP) entity, radio link control (RLC) entity, a logistical channel are set for each RB.

In the mobile communication system, for example, the LTE/LTE-A, up to eleven RBs may be set, and therefore eleven logical channels may be set. In the LTE/LTE-A, the base station determines the LCG allocation of the logical channels in consideration of the QCI values allocated to the logical channels of each terminal. In the LTE/LTE-A, the QCI values may be up to 9 and the QCI value is allocated to the logical channel. The logical channels may be divided into, for example, up to four LCGs and the corresponding logical channel is allocated to any LCG in consideration of the QCI values allocated to each logical channel.

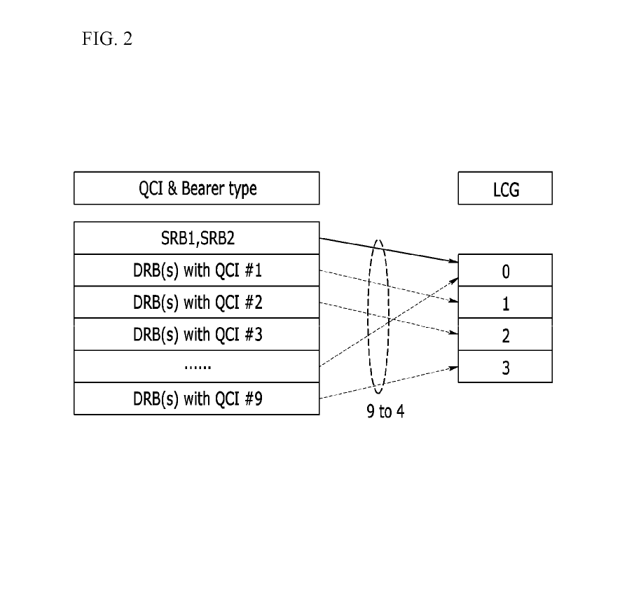

FIG. 2 is an exemplified diagram illustrating an LCG allocation relationship with the QCI of the RB.

As illustrated in the accompanying FIG. 2, signaling radio bearer (SRB) 1, SRB2, and data radio bearers (DRBs) having each QCI may be allocated to one of four LCGs. However, the SRBs are always allocated to LOGO.

When the services supported in the mobile communication system are provided while ensuring the QoS defined by the existing QCI, to support new low latency services such as real-time control and tactile internet that are required for the short transmission latency in the radio section, according to the exemplary embodiment of the present invention, new QCI values, that is, the QCI values for the RBs of the low latency service are further set (or defined) in the QCI values for the RBs of the existing service. In detail, new QCI values having higher priority and shorter delay time (packet delay) than the services provided from the existing mobile communication system (for example: LTE/LTE-A) may be set.

The following Table 3 is an example of representing the new QCI values added according to the exemplary embodiment of the present invention.

TABLE 3

| | Bearer | | Packet delay | Packet | |
|---|---|---|---|---|---|
| QCI | type | Priority | time | loss | Example |
| 1-9 | . . . | . . . | . . . | . . . | . . . |
| xx | GBR | <1 | 1 ms(OTA) + Δ₁ | 10⁻² | . . . |
| yy | Non-GBR | <1 or <2 | 1 ms(OTA) + Δ₂ | 10⁻⁶ | . . . |

QCI 1 to 9 are the existing QCIs and QCI xx and yy represent newly defined QCI values according to an exemplary embodiment of the present invention. Only one QCI value for new low latency service differentiated from the existing QoS may be additionally defined and up to L (e.g, L=2 or more) new QCI values differentiated from each other may also be added in consideration of priority, the packet delay time and the packet loss.

When the minimum two new QCI values are additionally set for the low latency service, the new QCI values may be set to be differentiated from the GBR and the non-GBR depending on the characteristics of the RB. In this case, similar to the existing QCI value, the RB type is configured so that the RB of GBR type has a priority value of a value smaller than the RB of non-GBR type. The smaller priority value indicates the higher scheduling priority.

When the new QCI values for the low latency service are added, the buffer status report message of the terminal, that is, the BSR message may be newly configured based on the LCG allocation scheme in consideration of the QCIs of the logical channels and transmitted.

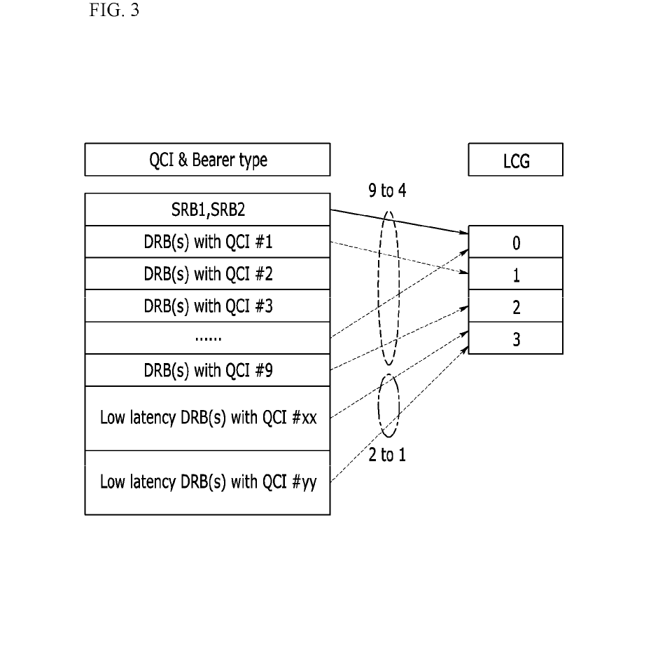

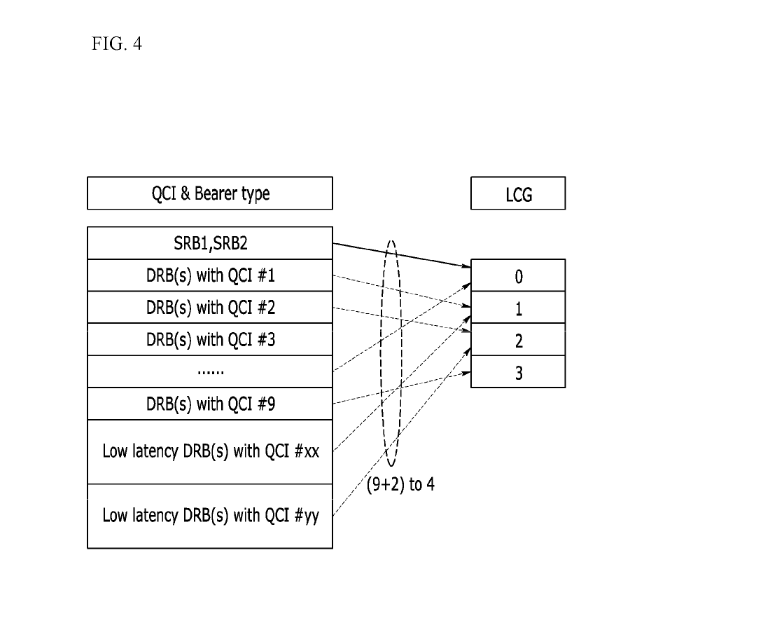

FIGS. 3 and 4 are exemplified diagrams illustrating the LCG allocation in consideration of the QCI according to a first exemplary embodiment of the present invention.

According to a first exemplary embodiment of the present invention, when the predetermined preset number, for example, four LCGs are allocated, the logical channels having the QCI values for the RB for the existing service and the logical channels having the newly defined QCI values for the RBs of the low latency service are allocated to the LCG together without changing the number of LCGs. For better comprehension and ease of description, hereinafter, the QCI value for the RB for the existing service is called the “QCI value of the existing service” and the QCI value newly defined for the RB for the low latency service is called the “QCI value of the low latency service”

To allocate the logical channel having the QCI value of the existing service and the logical channel having the QCI value of the low latency service to the LCG without changing the number of LCGs, two methods may be used.

By the first method, the logical channels (for convenience of description, may be called a first logical channel) having the QCI value of the low latency service are separately allocated from the logical channel (for convenience of description, may be called a second logical channel) having the QCI value of the existing service. That is, in the four LCG, the first logical channel having a newly added QCI value is allocated to one LCG and the logical channels having nine QCI values of the remaining existing service, that is, the second logical channels may be allocated to the rest three LCGs. For example, as illustrated in FIG. 3, the first logical channels having QCI values (QCI #xx, QCI#yy) of the low latency service according to the exemplary embodiment of the present invention are allocated to LCG 3 among four LCGs and the second logical channels having QCI values QCI#1 to QCI#9 f the existing service are allocated to one of the rest LOG0 to LCG2.

As such, when the logical channels having the QCI value newly defined for the low latency service are allocated to the LCG while being separated from the logical channels having the QCI value supporting the existing service, the BSR message transmitted from the terminal to the base station may reuse the existing message structure (message structure of the existing LTE/LTE-A).

Further, by the second method, the logical channels having the QCI values of the existing service and the logical channels having the QCI values of the newly defined low latency service are allocated to the four LCGs without differentiating from each other. For example, as illustrated in FIG. 4, the first logical channels having QCI values (QCI #xx, QCI#yy) of the low latency service according to the exemplary embodiment of the present invention each are allocated to LCG 1 and LCG 2 among four LCGs and the second logical channels having QCI values QCI#1 to QCI#9 f the existing service are allocated to one of the LOGO to LCG3 among four LCGs. The first logical channel and the second logical channel are allocated to four LCGs, respectively, without being differentiated from each other, such that there are LCGs (e.g., LCG1 and LCG2) to which both the first logical channels and the second logical channels are allocated.

As such, even when the logical channels having the QCI value newly defined for the low latency service are allocated to the LCGs without being separated from the logical channels having the QCI value supporting the existing service, the BSR message transmitted from the terminal to the base station may reuse the existing message structure (message structure of the existing LTE/LTE-A).

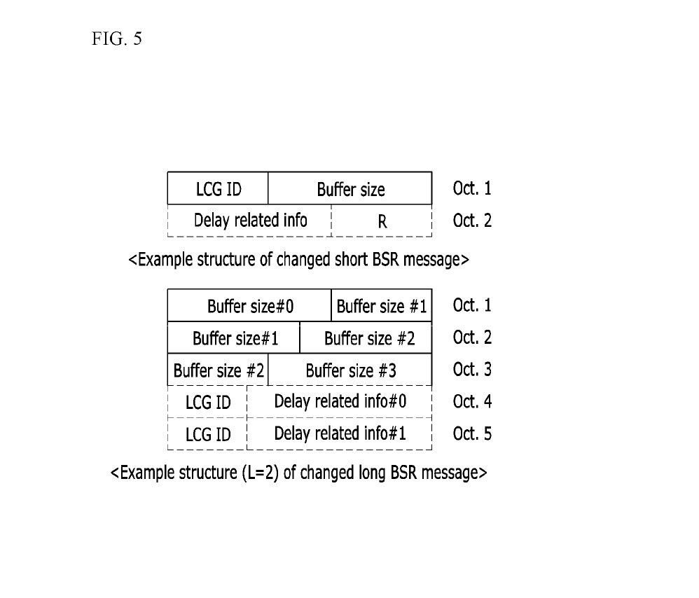

However, when the LCG allocation is made by the second method, the logical channels having the QCI values supporting the existing service and the logical channels having the new QCI value for the low latency service may be simultaneously mapped to one LCG. In consideration of this case, the structure of the BSR message may be changed. According to the exemplary embodiment of the present invention, the BSR message includes delay related information of packets accumulated in a buffer, in addition to buffer size information. Here, the delay related information of the packets may consist of M(M≦6) bits. The structure of the BSR message including the delay related information of the packets is as illustrated in FIG. 5.

FIG. 5 is an exemplified diagram illustrating a structure of a BSR message according to an exemplary embodiment of the present invention.

The BSR message type is divided into the short BSR message and the long BSR message. As illustrated in FIG. 5, the short BSR message for one LCG additionally includes the delay related information. In FIG. 5, R represents “reserved”. The long BSR message for all the LCGs includes the delay related information and may include the delay related information equal to or smaller than 4 that is the number of existing LCGs in consideration of the number L of QCIs newly defined for the low latency service. In this case, the BSR message having the structure changed according to the exemplary embodiment of the present invention may also include a separate identifier, that is, the LCID to be differentiated from the BSR message having the existing structure.

The delay related information may represent index values similar to the buffer size information. The following Table 4 represents the value of the delay related information for each index.

TABLE 4

| Index | Value of delay related information |
|---|---|
| 0 | 1 ms |
| 1 | 5 ms |
| 2 | 20 ms |
| . . . | . . . |

As the BSR message includes the delay related information of the packets, the base station may perform the resource allocation to meet the requirements of the low latency service RB. In this case, only in the case of the LCGs allocated to the logical channels of the low latency service RB, the BSR message may include the delay related information.

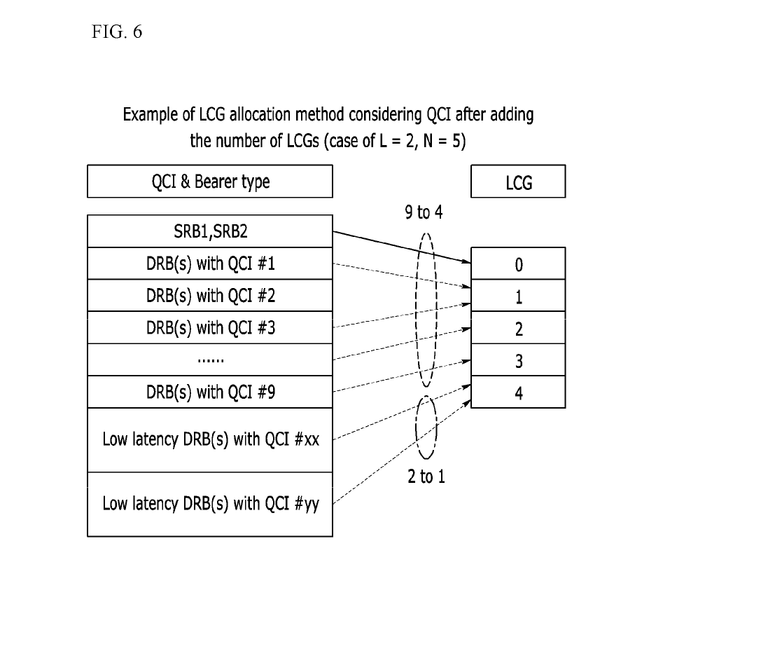

FIG. 6 is an exemplified diagram illustrating LCG allocation in consideration of QCI according to a second exemplary embodiment of the present invention.

According to the second exemplary embodiment of the present invention, to allocate the logical channels to the LCG in consideration of the QCI values newly defined for the low latency service, the number of LCGs is increased compared to the number of existing LCGs. That is, to transmit the buffer status information of the new RB differentiated from the existing RB to the base station so that the base station may perform the resource allocation to meet the requirements of the low latency service RB, the number of LCGs is increased in consideration of the QCIs newly defined for the low latency service.

As described above, when L (L=2) QCI values newly defined for the low latency service are added, the number of LCGs may be increased to N (e.g., (4+L)≦N≦5), instead of the existing four.

As illustrated in FIG. 6, the first logical channel and the second logical channel are allocated to the LCG while being separated from each other while using the N (N=5) (here, L=2) LCGs (LOG0 to LCG4). That is, the first logical channel having the QCI value of the low latency service is allocated to the LCG (LCG4) newly added in addition to the number of existing LCGs (LOG0 to LCG3) and the second logical channels having the QCI value of the existing service are allocated to the rest LCGs(LOG0 to LCG3).

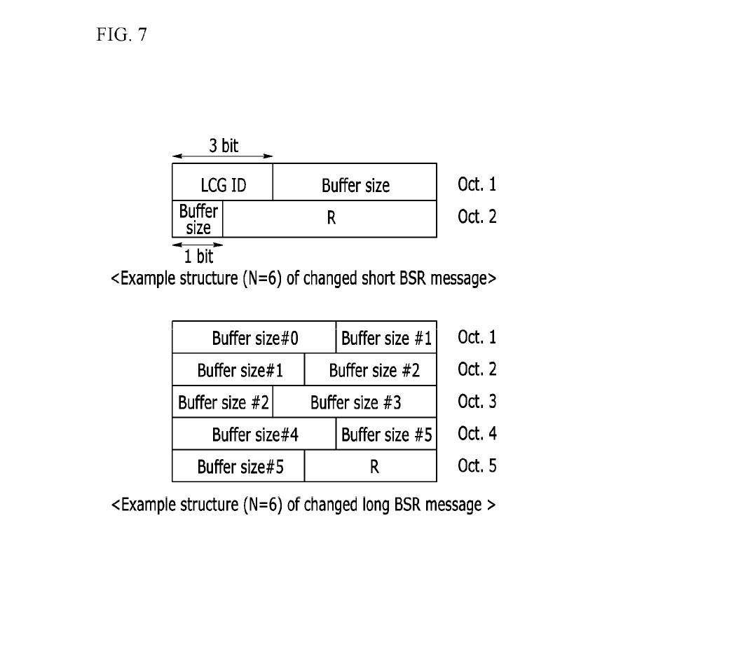

In addition, the first logical channel and the second logical channel may be allocated to five LCGs without being differentiated from each other while using N (N=5) (here, L=2) LCGs. For example, the first logical channels having the QCI value of the low latency service are allocated to one LCG among the five LCGs (LOG0 to LCG4) and the second logical channels having the QCI value of the existing service are allocated to one of five LCGs (LOG0 to LCG4). Meanwhile, according to the second exemplary embodiment of the present invention, to new N LCGs, a predetermined bit, that is, at least bits are required. In the mobile communication system (e.g., LTE/LTE-A), four LCGs are represented by 2 bits, while at least log₂N bits are required to represent new N LCGs. Therefore, according to the second exemplary embodiment of the present invention, the BSR message structure is changed and the changed BSR message has a structure as illustrated in FIG. 7.

FIG. 7 is an exemplified diagram illustrating a structure of a BSR message according to a second exemplary embodiment of the present invention.

FIG. 7 illustrates the BSR message in the case of supporting N (N=6) LCGs, in which the BSR message type is divided into the short BSR and the long BSR. To support the increased number of LCGs, when the BSR message structure changed as illustrated in FIG. 7 may be replaced by the BSR message structure of the existing LTE/LTE-A and used, the existing LCID may be used as it is. Alternatively, to differentiate the existing BSR message structure, the separate LCID may also be allocated to the changed BSR message structure.

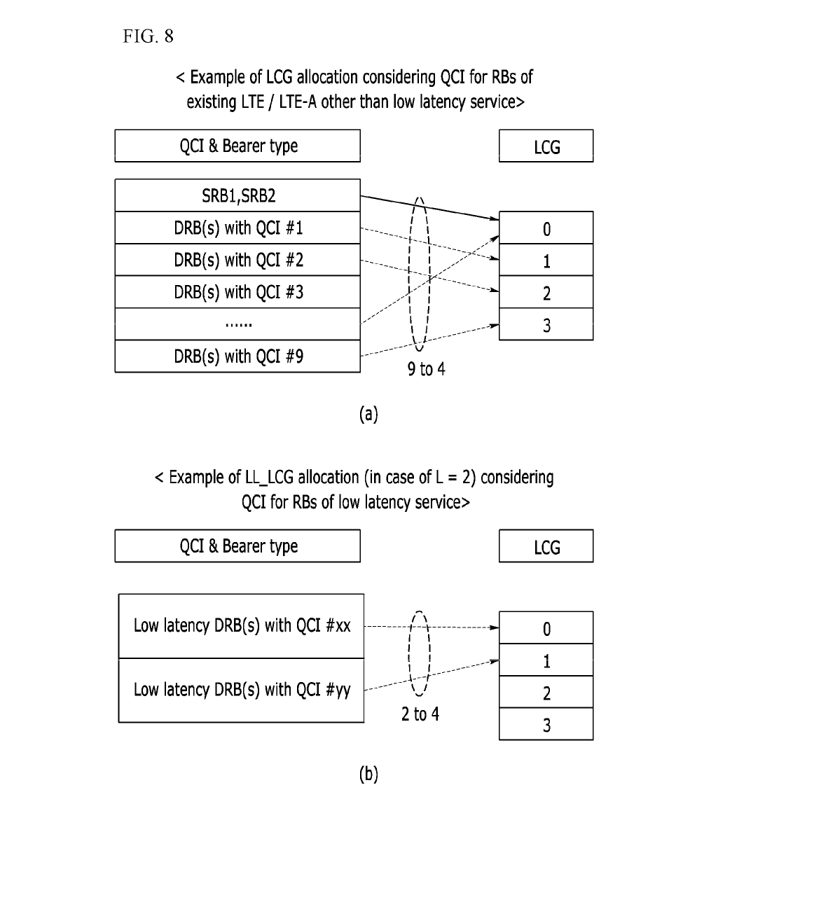

FIG. 8 is an exemplified diagram illustrating LCG allocation in consideration of QCI according to a third exemplary embodiment of the present invention.

The third exemplary embodiment of the present invention defines and uses the LCG for the separate low latency service differentiated from a predetermined number (for example: four) of LCGs for the existing service. The LCG for the low latency service may be called “low latency_LCG (LL_LCG)”. The number of LCGs separately defined for the low latency service may be equal to the number of existing LCGs. In this case, the LCG for the low latency service may be defined as up to four.

The second logical channels having the QCI values of the existing service are allocated to the existing four LCGs (LOG0 to LCG3) as illustrated in FIG. 8A. Further, the first logical channels having the QCI values of the low latency service are allocated to four LL_LCGs (LL_CG0-LL_LCG3) separately defined as illustrated in FIG. 8B.

As described above, when the RB for the low latency service is set, the LCG of the related logical channel is separately defined as the LL_LCG and the BSR message for the RBs associated with the low latency service, that is, the BSR message for the low latency service is configured as a message differentiated from the BSR message for the RBs associated with the existing service, that is, the BSR message for the existing service and is transmitted. That is, the BSR message (called LL_BSR message) for the low latency service and the BSR message for the existing service each are generated and transmitted. At this time, the BSR message for the low latency service, that is, the LL_BSR message uses the same message structure as the BSR message for the existing defined service.

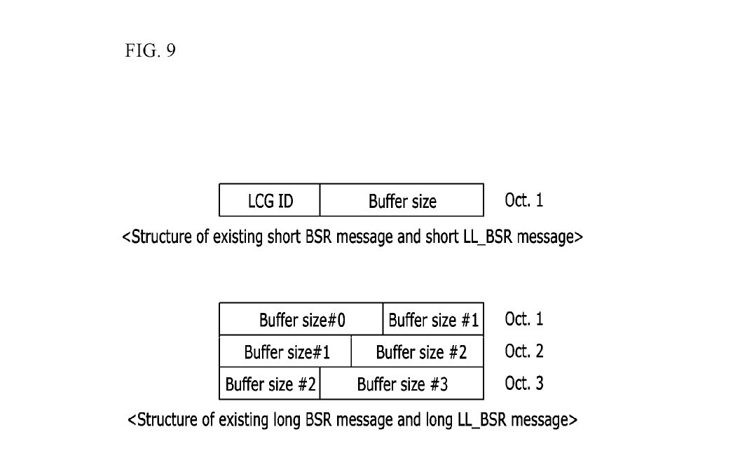

FIG. 9 is an exemplified diagram illustrating a structure of a BSR message according to a third exemplary embodiment of the present invention.

According to the third exemplary embodiment of the present invention, the type of the BSR message is divided into the short BSR message and the long BSR message and as illustrated in FIG. 9, the short BSR message for the low latency service and the short BSR message for the existing service are individually generated while having the same structure and transmitted. Further, the long BSR message for the low latency service and the long BSR message for the existing service are also generated individually while having the same structure and transmitted.

Meanwhile, the BSR for the existing service and the BSR (LL_BSR) for the low latency service may be divided by the LCID used to differentiate the control message of the MAC layer and the LCID having values different from the LCID representing the BSR message for the existing service may be newly allocated to the BSR message for the low latency service.

According to the first to third exemplary embodiment of the present invention as described above, the LCG allocation considering the QCI is performed and a new LCID may be allocated to the BSR message for the low latency service while generating the BSR message depending on the LCG allocation.

For the BSR message for the existing service, as shown in the above Table 1, three LCID values of 11100 to 11110 are allocated

For the BSR message for the low latency service that is changed from the structure of the BSR message for the existing service or is differentiated from the BSR message for the existing service, some of LCID values (for example, 01100-10101) that are not used conventionally are allocated. The following Table 5 shows the new LCID values allocated to the BSR (LL_BSR) message for the low latency service according to the exemplary embodiment of the present invention.

TABLE 5

| | |
|---|---|
| 01100 | LL Truncated BSR |
| 01101 | LL Short BSR |
| 01110 | LL Long BSR |

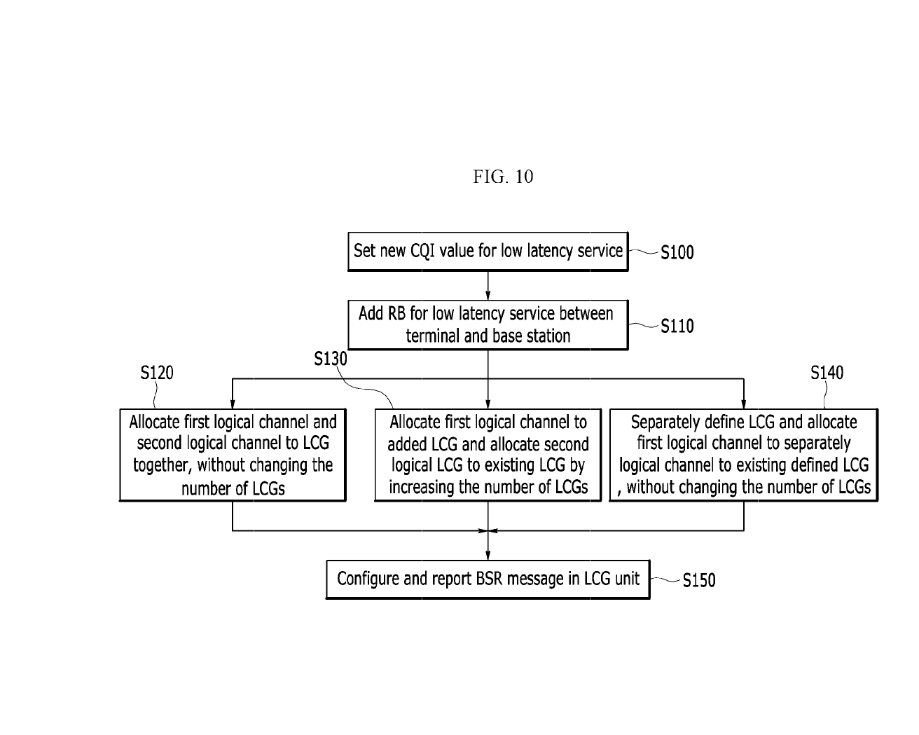

FIG. 10 is a flow chart of a method for a buffer status report according to an exemplary embodiment of the present invention.

To support the RB for the low latency service requesting the QoS different from the existing service, a newly defined QCI value is set to the low latency service (S100). The separate RB for the low latency service is additionally set as the existing procedure and method without changing the bearer setting procedure, or the like for the existing service between the terminal and the base station (S110).

Considering the QCI newly defined to support the RB for the low latency service requesting the QoS different from the existing service, the logical channel of the RB for the existing service and the logical channel of the RB for the low latency service are allocated to the LCGs.

In detail, as described above, the logical channels (first logical channels) having the newly defined QCI values for the RB for the low latency service and the logical channels (second logical channels) having the QCI values for the RB for the existing service are allocated to the LCG together, without changing the number of LCGs. (S120). In this case, the first method or the second method may be used.

Alternatively, the number of LCGs is increased, the logical channels (first logical channels) having the QCI values newly defined for the RB for the low latency service are allocated to LCG newly added, and the logical channels (second logical channels) having the QCI values for the RB for the existing service are allocated the existing LCG (S130).

Alternatively, the separate LCGs for the low latency service are defined, the logical channels (first logical channels) having the QCI values newly defined for the RB for the low latency service are allocated to separately defined LCG, that is, the LCGs for the low latency service and the logical channels (second logical channels) having the QCI value for the RB for the existing service are allocated to the existing defined LCG, that is, the LCGs for the existing service (S140).

Hereinafter, the buffer status report is performed in each LCG unit. The BSR message is configured depending on the buffer status report, the terminal transmits the so configured BSR message to perform the buffer status report, and the base station receives the BSR message depending on the buffer status report (S160). In this case, the structure of the message may be changed according to each allocation method (S120 to S140), which may be appreciated on the basis of the above-mentioned exemplary embodiment of the present invention, and therefore the detailed description thereof will be omitted.

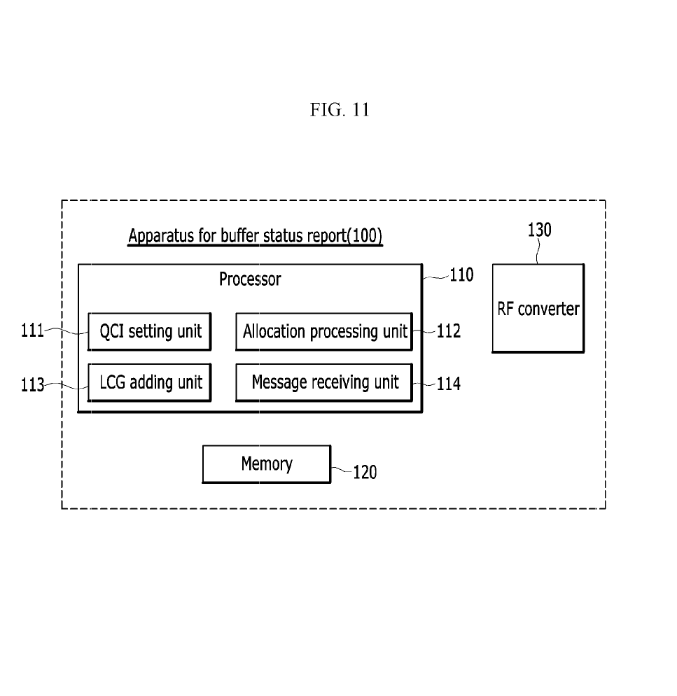

FIG. 11 is a configuration diagram of an apparatus for a buffer status report according to an exemplary embodiment of the present invention.

As illustrated in FIG. 11, an apparatus 100 for a buffer status report according to an exemplary embodiment of the present invention includes a processor 110, a memory 120, and a radio frequency (RF) converter 130. The processor 110 may be configured to implement the methods with reference to FIGS. 3 to 10.

For this purpose, the processor 110 may further include a QCI setting unit 111, an allocation processing unit 112, an LCG adding unit 113, and a message receiving unit 114.

When the separate RB for the low latency service is added, the QCI setting unit 111 sets a new QCI value for supporting the RF of the low latency service requesting QoS different from the existing service as well as the QCI allocation of the RB for the existing service.

The allocation processing unit 112 allocates the logical channels of the RB to the LCG in consideration of the set QCI value.

The LCG adding unit 113 increases the number of exiting LCGs or sets the separate LCG for the low latency service. When the number of LCGs is increased, the number of LCGs may be increased to N (e.g.,(k+L)>=N). Here, the L is the number of QCI values newly defined for the low latency service, in which k is the number of existing LCGs.

Meanwhile, the allocation processing unit 112 allocates both of the logical channels having the QCI values of the low latency service and the logical channels having the QCI values of the existing service to the LCG when the number of LCGs is not changed and uses the first method or the second method according to the first exemplary embodiment of the present invention to allocate the logical channels to the LCG.

Alternatively, the allocation processing unit 112 allocates the logical channels having the QCI values of the low latency service to the LCG newly added by the increase in the number of LCGs when the number of LCGs is increased by the LCG adding unit 113 and allocates the logical channels having the QCI values of the existing service to the existing LCG.

Alternatively, the allocation processing unit 112 allocates the logical channels having the QCI values of the low latency service to the LCGs for the low latency service and allocates the logical channels having the QCI values of the existing service to the LCGs for the existing service when the LCG for the low latency service is separately defined by the LCG adding unit 113 and thus the LCG for the existing service and the LCG for the low latency service are present.

The message receiving unit 114 receives the BSR message performing the buffer status report in each LCG unit. In this case, the structure of the message may be changed according to the allocation method of the allocation processing unit 112. For example, the BSR message may be configured in the form in which it includes the delay related information of the packets that are accumulated in the buffer. Further, a new LCID may be allocated to the BSR message for the low latency service.

The memory 120 is connected to the processor 110 and stores various types of information associated with the operation of the processor 110. The RF converter 130 is connected to the processor 110 to transmit and receive a radio signal.

The exemplary embodiments of the present invention are not implemented only by the apparatus and/or method as described above, but may be implemented by programs recorded in a recording medium for realizing the functions corresponding to the configuration of the exemplary embodiments of the present invention or the recording medium recorded with the programs, which may be readily implemented by a person having ordinary skill in the art to which the present invention pertains from the description of the foregoing exemplary embodiments.

While this invention has been described in connection with what is presently considered to be practical example embodiments, it is to be understood that the invention is not limited to the disclosed embodiments, but, on the contrary, is intended to cover various modifications and equivalent arrangements included within the spirit and scope of the appended claims.

What is claimed is:

1. A method for a buffer status report, comprising:
setting a new QoS class identifier (QCI) value for supporting a radio bearer (RB) added for a low latency service; and
allocating a logical channel of a RB for an existing service and a logical channel of a RB for the low latency service to logical channel groups (LCGs) in consideration of the newly set QCI value.

2. The method of claim 1, wherein:
the allocating of the logical channels to the LCGs includes:
allocating the logical channel of the RB for the low latency service and the logical channel of the RB for the existing service to the LCGs, respectively, without changing the number of existing defined LCGs

3. The method of claim 2, wherein:
the allocating of the logical channels to the LCGs, respectively, includes:
separately allocating the logical channel of the RB for the low latency service and the logical channel of the RB for the existing service to the LCGs, respectively; and
allocating the logical channel of the RB for the low latency service and the logical channel of the RB for the existing service to the LCGs, respectively;
without differentiating the logical channels.

4. The method of claim 3, wherein:
when the logical channel of the RB for the low latency service and the logical channel of the RB for the existing service are allocated to the LCGs, respectively, without differentiating the logical channels,
the performing of the buffer status report includes
configuring a buffer status report message additionally including delay related information of packets and transmitting the configured buffer status report message.

5. The method of claim 4, wherein:
only the buffer status report messages for the LCGs to which the logical channels of the RB for the low latency service are allocated include the delay related information.

6. The method of claim 1, wherein:
the allocating of the logical channels to the LCGs includes:
allocating the logical channel of the RB of the low latency service and the logical channel of the RB of the existing service to the LCGs, respectively, by increasing the number of existing defined LCGs.

7. The method of claim 6, wherein:
in the allocating of the logical channels to the LCGs, respectively,
the logical channel of the RB for the low latency service is allocated to the LCG added depending on the increase in the number of LCGs and the logical channel of the RB for the existing service is allocated to the existing LCG.

8. The method of claim 1, wherein:
the allocating of the logical channels to the LCGs includes:
separately defining the LCGs for the low latency service in addition to the existing defined LCGs, and
allocating the logical channel of the RB for the low latency service to the LCGs for the separately defined low latency service and allocating the logical channel of the RB for the existing service to the existing defined LCGs, respectively.

9. The method of claim 1, wherein:
in the receiving of the buffer status report,
a buffer status report message for the buffer status report for each logical channel is received and a buffer status report message for the logical channel of the RB for the existing service and a buffer status report message for the logical channel of the RB for the low latency service are allocated different logical channel IDs (LCIDs).

10. An apparatus for a buffer status report, comprising:
a radio frequency converter transmitting and receiving a signal through an antenna; and
a processor connected to the radio frequency converter and allocating a logical channel group (LCG) and processing the buffer status report,
wherein the processor includes:
a QCI setting unit setting a new QoS class identifier (QCI) value for supporting a radio bearer (RB) added for a low latency service; and
an allocation processing unit allocating a logical channel of a RB for an existing service and a logical channel of a RB for the low latency service to logical channel groups (LCGs) in consideration of the newly set QCI value.

11. The apparatus of claim 10, wherein:
the allocation processing unit
allocates the logical channel of the RB for the low latency service and the logical channel of the RB for the existing service to the LCGs, respectively, while differentiating the logical channels or allocates the logical channel of the RB for the low latency service and the logical channel of the RB for the existing service to the LCGs, respectively, without differentiating the logical channels, without changing the number of existing defined LCGs.

12. The apparatus of claim 10, wherein:
the processor further includes:
an LCG adding unit increasing the number of existing defined LCGs for the buffer status report or separately defining the LCG for the low latency service.

13. The apparatus of claim 10, wherein:
the processor further includes
a message receiving unit receiving the buffer status report for each logical channel performed in an LCG unit,
the message receiving unit receives a buffer status report message additionally including delay related information of packets when the allocation processing unit allocates the logical channel of the RB for the low latency service and the logical channel of the RB for the existing service to the LCGs, respectively, without differentiating the logical channels.
